(19) United States
(12) Patent Application Publication
(10) Pub. No.: US 2013/0117838 A1
(43) Pub. Date: May 9, 2013

(54) Superpositional Control of Integrated Circuit Processing

(71) Applicants: Timothy Evert LEVIN, Pacific Grove, CA (US); Timothy Peter Sherwood, Santa Barbara, CA (US); Theodore Douglas Huffmire, Monterey, CA (US); Cynthia Emberson Irvine, Pebble Beach, CA (US); Ryan Charles Kastner, San Diego, CA (US); Thuy Diep Nguyen, Salinas, CA (US); Jonathan Kaveh Valamehr, Granada Hills, CA (US)

(72) Inventors: Timothy Evert LEVIN, Pacific Grove, CA (US); Timothy Peter Sherwood, Santa Barbara, CA (US); Theodore Douglas Huffmire, Monterey, CA (US); Cynthia Emberson Irvine, Pebble Beach, CA (US); Ryan Charles Kastner, San Diego, CA (US); Thuy Diep Nguyen, Salinas, CA (US); Jonathan Kaveh Valamehr, Granada Hills, CA (US)

(21) Appl. No.: 13/025,946

(22) Filed: Feb. 11, 2011

Related U.S. Application Data
(60) Provisional application No. 61/303,422, filed on Feb. 11, 2010.

(51) Int. Cl. G06F 21/00

(52) U.S. Cl. 726/16; 726/34

(57) ABSTRACT

Specialized hardware functions for high assurance processing are seldom integrated into commodity processors. Furthermore, as chips increase in complexity, trustworthy processing of sensitive information can become increasingly difficult to achieve due to extensive on-chip resource sharing and the lack of corresponding protection mechanisms. Embodiments in accordance with the invention allow for enhanced security of commodity integrated circuits, using minor modifications, in conjunction with a separate integrated circuit that can provide monitoring, access control, and other useful security functions. In one embodiment, a separate control plane, stacked using 3-D integration technology, allows for the function and economics of specialized security mechanisms, not available from a coprocessor alone, to be integrated with the underlying commodity computing hardware.

### CROSS REFERENCE TO RELATED APPLICATION

This application claims the benefit of U.S. Provisional Application No. 61/303,422, filed Feb. 11, 2010, which is hereby incorporated in its entirety by reference.

### BACKGROUND OF THE INVENTION

1. Field of the Invention

This invention relates generally to security in computer processors and particularly to automated enforcement of security policies in such processors.

2. Description of the Related Art

The development effort required to build a system is directly proportional to the cost of its failure; hence critical systems used in space shuttles and banks undergo much more rigorous development cycles than systems for home users. Such high assurance, trustworthy systems require a tremendous investment of time, effort, and money by their small community of users, and, in comparison to commodity systems, lag far behind in performance and programmability. Unfortunately, for commodity processors, security threats are often not considered at the rapidly changing Instruction Set Architecture (ISA) or micro-architecture levels. Allowing commodity parts to be retrofitted with protection mechanisms without increasing the cost for ordinary users would offer a significant advantage for high assurance system development.

The economics of trustworthy system development has placed designers under constraints not faced by low assurance, commodity systems. For example, the expense of special purpose hardware can make it costlier to provide both high performance and strong security. Even when hardware vendors incorporate security enhancements, integrating these mechanisms into a complex system design may present many practical and theoretical problems, driving up the costs and driving out the release schedule. This is especially true at the highest Common Criteria Evaluation Assurance Levels (EALs). A 2006 GAO report analyzing the cost of Common Criteria evaluations (of the more common EAL2, EAL3, and EAL4 variety) found, not surprisingly, that higher assurance levels tend to be costlier and more time-consuming. In addition to the fact that such system development costs per unit are very high, users requiring such functionality make up a small portion of the market. Sophisticated security mechanisms at the hardware level are typically targeted at a relatively small market sector and add unacceptable costs to commodity products.

Due to the high non-recurring engineering (NRE) cost of manufacturing custom hardware and the small amortization base of low volume products, manufacturers are often forced to choose less costly alternatives, such as an older, cheaper process (e.g., 0.5 μm vs. 45 nm). For this reason, the gap in performance between low volume (e.g., military) and commercial systems grows every year, with commercial hardware performance dominating by a factor of one hundred—a gap that did not exist thirty years ago. For example, according to the Institute for Defense Analyses, The United States Department of Defense (DOD)], as a low-volume customer, has benefited from some of this explosion in the commercial integrated circuit market, but DOD has increasingly encountered challenges in getting appropriate and affordable access to technology and products.

As a result of these economic factors, designers of trustworthy systems requiring high performance need some way to incorporate commercial hardware components without compromising security. Modern integrated circuit devices for general purpose processing (“GP processors”) are complex and expensive. While highly refined, market economics demand that GP processors address the general case, in which it is not possible to include in the integrated circuit dedicated mechanisms to enforce security policies during processing. The general design paradigm is that the GP processor should include only those mechanisms and functions that cannot be implemented efficiently as a software program that comprises invocations of the mechanisms already provided by the GP processor.

An operating system (“OS”) is a software program that provides instructions directly to the GP processor. An OS is responsible for managing the physical resources of the computer (e.g., main memory, disk memory, and various I/O devices), via GP processor instructions, while providing an execution environment for applications to access (abstractions of) those resources in a “secure” way. The definition of “secure” varies from OS to OS, and a given configuration of hardware and software results in what is called the computer's “automated security policy.” Mechanisms to control the actions of active elements of a computer system are sometimes called reference monitors when they are non-bypassable, self-protecting, and minimized.

It is difficult to maintain the confidentiality and integrity of data that is processed by a GP processor. To do so with a high degree of assurance requires purpose-built “secure operating systems” that require precise validation of correctness, and are therefore expensive. Commercial operating systems cannot be depended upon to enforce many automated security policies, such as those required to protect highly valued information.

“Multi-die” technology provides a way to add circuitry to a GP processor, for passively observing its behavior, without requiring much change to the GP processor. Recent research in “multi-die” integrated circuit technology has provided a minimally invasive means to integrate monitoring circuits into the GP processor. In this approach, sockets, each of which can accept a communication post, are integrated into the design of the GP processor, such that it can be manufactured with or without an additional die used for security purposes. During the manufacture of the GP processor, if it is to be enhanced with this extra circuitry, another die (the “control plane”) is attached to the GP processor (viz., the “computation plane”), in such a way that signals can pass between the planes through specific “vias” or “posts” that connect to the sockets. This method was originally designed for passive monitoring, and to date all publications on this subject have been limited to passive monitoring.

Commercial operating systems do not adequately control the activities of applications that they host in a secure manner. Addition of software logic to these OSs is not a feasible solution, as the OS is too complex to be able to verity that the resulting enhanced OS would enforce the desired automated security policy. Secure operating systems incorporate the desired software logic for controlling applications in a secure and verifiable manner. However the development and verification processes required to provide a high assurance of the correctness of enforcement of the automated security policy result in a high cost.

### SUMMARY OF THE INVENTION

Embodiments in accordance with the invention disentangle specialized security mechanisms from the commodity design and provide the addition of security functionality to a processor as a foundry-level configuration option. In accordance with one embodiment, a computing system includes: a computation plane that includes one or more dies arranged for performing computation, which, in certain instances, is required to be secure; a control plane that includes one or more dies performing operations necessary to ensure the security of the entire system; a plurality of direct electrical connections between the computation plan and control plane; and a plurality of electronic interfaces arranged to allow the control plane to activate and control portions or the whole of the computation plane for the purposes of increasing the security of its operation.

In accordance with another embodiment, a method for controlling access of a computer processor to a resource includes: (a) blocking uncontrolled access of the computer processor to the resource; (b) providing a control plane that includes data corresponding to a security policy; (c) providing a first signal post between the computer processor and the control plane to transfer signals from the computer processor to the control plane; (d) modifying signals from the computer processor so that the signals conform to the security policy; and (e) enabling the computer processor to have access through the control plane to transfer signals to the resource that conform to the security policy.

In accordance with a further embodiment, a security system for controlling access of a computer processor to a resource includes: a control plane that includes data corresponding to a security policy; a first signal post connected between the computer processor and the control plane to transfer signals from the computer processor to the control plane; a second signal post connected between the computer processor and the control plane to transfer signals that conform with the security policy from the computer processor to the resource; an apparatus in the control plane for modifying signals from the computer processor so that the signals conform to the security policy so that the computer processor is connected through the control plane to transfer signals to the resource that conform to the security policy; a cache eviction monitor located in the control plane for eliminating access-driven cache side channel attacks; memory elements connected to the computer processor for storing security bits that hold the permissions of a process to evict shared cache entries of other processes; and comparator circuitry arranged for comparing the security bits with instructions to load or store data to determine whether to allow a cache eviction.

Embodiments in accordance with the invention are best understood by reference to the following detailed description when read in conjunction with the accompanying drawings.

### BRIEF DESCRIPTION OF THE DRAWINGS

FIG. 1 represents a GP processor with one core connected to an on-chip resource;

FIG. 2 represents a GP processor with a multi-die control plane;

FIG. 3 represents a chip multiprocessor having two cores in a computation plane and a resource in a control plane;

FIG. 4 shows application of the invention to a shared cache in which pairs of override/signal posts route all interactions between the cores and an L2 cache through the control plane.

FIG. 5 shows low level architecture for routing data and control lines on a computation plane through a three-dimensional control plane;

FIG. 6 is a circuit diagram of sleep transistors in a computation plane being used to remove power from a selected circuit;

FIGS. 7(A)-7(D) show various circuit level modifications that can be made

FIG. 8 shows an architecture of a central processing unit/cache memory hierarchy and a three-dimensional cache eviction monitor working in concert;

FIG. 9 is a flow chart showing how loads and stores are executed when the Three-dimensional control plane is in place; and

FIG. 10 shows a high level logical overview of how the cache and the control plane interact in the cache monitor and further shows the control plane's responsibilities when it is active.

### DETAILED DESCRIPTION OF THE INVENTION

Embodiments in accordance with the invention provide a new and modular way to add security mechanisms to current and next generation processors through the use of 3-D interconnects. In one embodiment, these security mechanisms are implemented in a physical overlay including a separate plane of circuitry stacked on top of a commodity integrated circuit, e.g., chip. In various embodiments, the security mechanisms that reside in this overlay can be connected to the underlying chip with a variety of interconnect technologies, yet can be completely omitted without change to the commodity chip's function and without affecting its cost.

Embodiments in accordance with the invention provide means for integrating dedicated security-enforcement functions into the circuits of a GP processor while perturbing the GP processor to a small enough degree that the changes are acceptable to GP processor manufacturers. Accordingly embodiments in accordance with the invention provide an innovative application of multi-die technology for actively controlling the activities of the GP processor to enable more secure processing with commercial operating systems and to lower the cost of secure operating systems.

Embodiments in accordance with the invention utilize an active layer, herein called a 3-D control plane, which is specifically dedicated to security to implement a variety of security functions in a cost-effective and computationally efficient way. Specifically, embodiments in accordance with the invention provide a method for using 3-D integration for trustworthy system development, and combine an independently fabricated 3-D control plane containing arbitrary security functions, such as micro-architectural protection mechanisms, along with a commodity integrated circuit, referred to henceforth as the computation plane.

Security functions can be broadly classified as either active or passive monitors, depending upon whether the 3-D control plane modifies signals on the computation plane. Embodiments in accordance with the invention include precise circuit level primitives to build both active and passive monitors such that signals on the computation plane can be arbitrarily tapped, disabled, re-routed, or even overridden. Also disclosed herein is an exemplary overview of how the 3-D control plane can be integrated in a purely optional and minimally intrusive manner with very minor modification to the commodity computation plane.

In accordance with one embodiment, two pieces of silicon are fused together to form a single chip. The two active layers of the silicon, the commodity computation plane and 3-D control plane, are connected through inter-die vias, such as micron-width wires that are, e.g., chemically “drilled-and-filled” between the layers, that run vertically between the active layers. This ability to interconnect multiple active layers enables the optional addition of a plane to a processor specifically for security. This 3-D control plane has access to the security dependent signals of the system. A processor with this ability could be provided to customers requiring, for example, mechanisms to control information flow when security policies must be enforced or other security-specific support, whereas commodity systems simply might not include this extra, more costly, 3-D control plane.

For certain architectural arrangements of control features and computation cores, embodiments in accordance with the invention allow the secure processing of information using commercial OSs. Such arrangements include but are not limited to the use of multiple-core GP processors (“chip multi-processors,” or CMP), where a distinct OS is dedicated to managing each core, and each core is dedicated to processing information of one of several mutually suspicious activities, and the control plane is configured to control the interactions between cores.

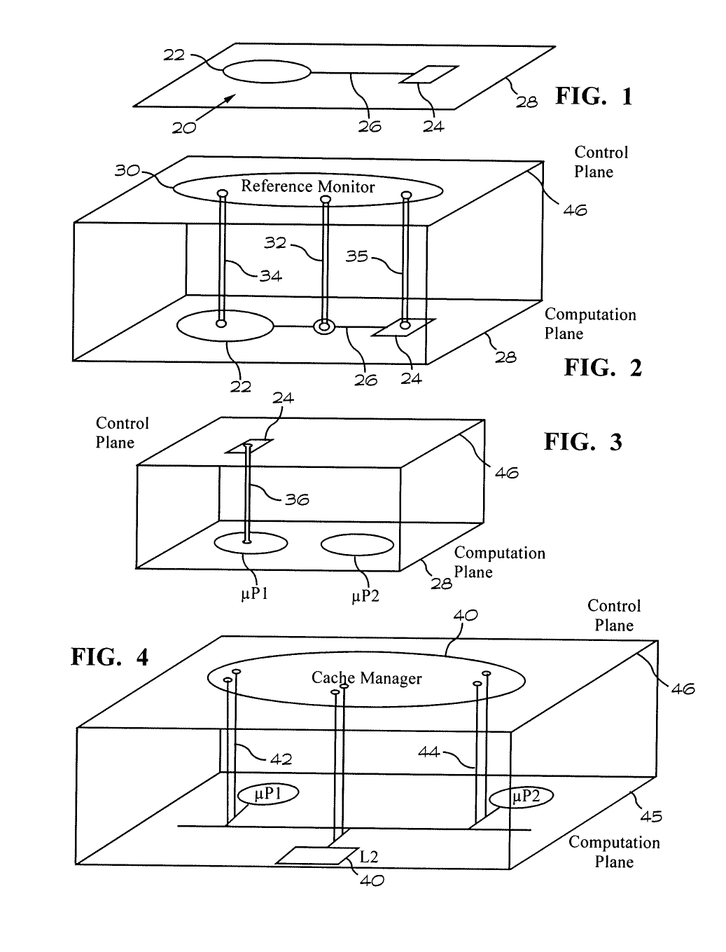

Referring now particularly to FIG. 1, in accordance with one embodiment, in a GP processor 20, an active element 22, such as a single core microprocessor (μP), accesses a resource 24 that is physically located either on or off of processor 20, through a private or shared (e.g., bus) connection 26. There may be reasons to control access by active element 22 to resource 24; such as if the core of active element 22 has multiple threads whose contention for exclusive access to resource 24 can interfere with each other in a manner called a covert channel. In general, interactions comprise one-way electrical pulses (signals) that are interpreted as requests or responses by the receiver of the signal.

In one embodiment, active element 22 is separated from resource 24 and any signals that would have transited between active element 22 and resource 24 are routed to a control plane (using the multi-die method), which modifies the signals so that their effects conform with an automated security policy before routing them back to a computation plane.

Separation of active element 22 from a given resource 24 can be achieved by various means during the processor's lifecycle (e.g., design, manufacture, installation, or initialization). For example, during processor design, separation can be provided by ensuring there are no physical or logical electrical connections. Separation can be achieved through configuration of resources during installation or initialization if that (configuration) is included as a native capability of GP processor 20; and separation can be provided after manufacture through physically altering the circuitry. In particular, in accordance with one embodiment an override post installed during manufacture of GP processor 20 is included that provides separation, which requires minimal changes to the native processor electronics.

Referring to FIG. 2, changes regarding access to resource 24 can be achieved in several ways through the actions of a reference monitor 30 on a control plane 46; by relocating resources to control plane 46 and only providing connections to resources 24 that conform to the automated security policy or simply through the effect of separation.

As shown in FIG. 2, an original connection is blocked by an activating post 32, and a signal post 34 routes all interactions between the core of active element 22 and resource 24 through control plane 46. As can be understood by those of skill in the art the location of signal post 34 on a given circuit depends on the layout of elements in that particular circuit. In one embodiment, logic on control plane 46 manages interaction of the core of active element 22 with resource 24 in a manner that conforms to the automated security policy.

As shown in FIG. 3, alternatively, resource 24, such as a memory region, can be relocated to control plane 46, where access to resource 24 is controlled through a signal post 36. For example, in a chip multiprocessor (CMP) 28, access to resource 24 can be provided to one of a pair of cores μP1 and μP2 once resource 24 has been moved to control plane 46.

FIG. 4 shows application of the invention to the problem of a CMP shared cache 40, in which pairs of override/signal posts 42 and 44 route all interactions between the cores μP1 and μP2 and the L2 cache 40 through control plane 46. Cache manager logic 40 on control plane 46 manages interaction between cores μP1 and μP2 with L2 cache 40 to eliminate interference.

In various embodiments, control plane 46 may be implemented in various circuit technologies, including FPGA and ASIC. Further embodiments in accordance with the invention can be applied to a wide variety of computational circuits, including but not limited to General Purpose processors, FPGAs and ASICs. In various embodiments, the computation plane 45 can be a single core or CMP.

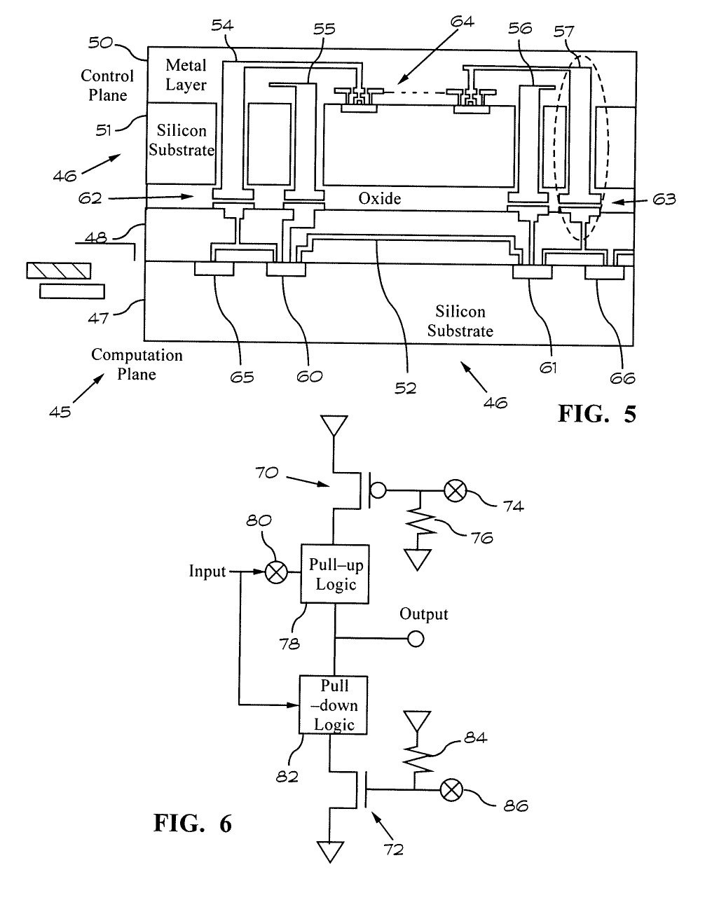

FIG. 5 shows the low level architecture for routing data/control lines on a computation plane 45 through a 3-D control plane 46. In one embodiment, computation plane 45 includes a silicon substrate 47 upon which a metal layer 48 is formed. An oxide layer 62 is formed on metal layer 48.

In one embodiment, control plane 46 includes a metal layer 50 formed on a silicon substrate 51. This arrangement can be utilized to disable a bus 52 on computation plane 45 to ensure resource isolation. In one embodiment, computation plane 45 and 3-D control plane 46 are connected with inter-die vias, or through-silicon vias (TSVs) 54-57, which serve as posts. Posts are required to tap the required signals necessary for the security logic. In one embodiment, sleep transistors connected to posts 55 and 56 are used to disable bus 52 on computation plane 45. In one embodiment, posts 54 and 57 carry the rerouted signal from computation plane 45 to control plane 46, where reference monitor logic 64 enforces a security policy on the rerouted bus traffic. FIG. 5 shows how tapping and disabling are used in conjunction to achieve rerouting and overriding.

Referring to FIG. 5, when access by an active component 22 (e.g., core) to a connection (e.g., bus) is provided through other components, such as tristate buffers 60 and 61, tri-state buffers 60 and 61 can be disabled to block the connection by inserting sleep transistors connected to posts 55 and 56. The sleep transistors are configured to turn off tri-state buffers 60 and 61 when posts 55 and 56, respectively, are in place. When posts 55 and 56 are not present, the component-connection traffic proceeds as normal. Signal posts 54 and 57 are placed so that they route any signals on tri-state buffers 60 and 61, respectively, to control plane 46, when disabling posts 55 and 56, respectively, are in place.

In one embodiment, posts 54 and 57 are connected between active monitor logic 64 in control plane 46 to CMOS logic circuits 65 and 66 in the computation plane 45. In one embodiment, 3-D control plane 46 can include several security functions on one chip. These functions can be implemented as either passive or active monitors. Notably, embodiments in accordance with the invention provide the ability for active monitoring of computation plane 45 in 3-D control plane 46.

One use of 3-D control plane 46 is to act as a passive monitor, simply accessing and analyzing data from computation plane 45. For example, control plane 46 can monitor accesses to a particular region of memory or audit the use of a particular set of instructions. To monitor these events, it is necessary to know when such events are occurring, which necessitates tapping some of the wires from the processor. This requires adding posts and vias to the instruction register and memory wires to gain direct access to the currently executing instruction. Passive monitoring can be implemented in 3-D technology, utilizing a set of vias to the top of computation plane 45, and then post 57 from there to 3-D control plane 46.

Whereas passive monitoring allows for auditing, anomaly detection and the identification of suspicious activities, systems enforcing security policies often require strong guarantees about restrictions to overall system behavior. Embodiments in accordance with the invention allow the use of active monitors to control information flow between cores, the arbitration of communication, and the partitioning of resources.

The key ability needed to support such functionality is to reroute signals to control plane 46 and then override them with potentially modified signals. With this technology and minor modification of computation plane 45, all inter-core communication, memory accesses, and shared signals can be forced to travel to control plane 46 where they are subject to both examination and control. For example, active monitoring can ensure that confidential data being sent between two cores (which are traditionally forced to traverse a shared bus) is not leaked to an unintended third recipient with access to that bus.

In one embodiment, modifying signals on computation plane 46 is accomplished in two parts. The first part is to ensure that the monitor has unfettered access to all the signals (tapping), which is, in essence, the same as the passive monitoring scenario described above. The second part is to selectively disable those links, essentially milling off portions of the computation plane (e.g. a bus), or override them to inject different values. The difficulty is that a capability (the connection between two components) is removed only by adding control plane 46 (which cannot physically cut or impede that wire). Computation plane 45 must be fully functional without an attached 3-D control plane 46, yet it needs to be constructed so that by wiring in some extra circuitry the targeted capability can be completely disabled. To accomplish this, components in computation plane 45 must be modified to support the active monitoring.

FIG. 6 is a circuit diagram of sleep transistors 70 and 72 in computation plane 45 being used to remove power from a certain circuit. In addition to this, existing sleep transistor technology can be applied to provide new functions in computation plane 45, dictated by 3-D control plane 46. In one embodiment, a PMOS sleep transistor 70 is connected to an override via 74, a pull-down resistor 76 and pull-up logic 78. Input to pull-up logic 78 is also connected to a signal via 80. The input is also connected to a pull-down logic 82, which is connected to pull-up transistor 72. Pull-up transistor 72 is further connected to a resistor 84 and an override via 86.

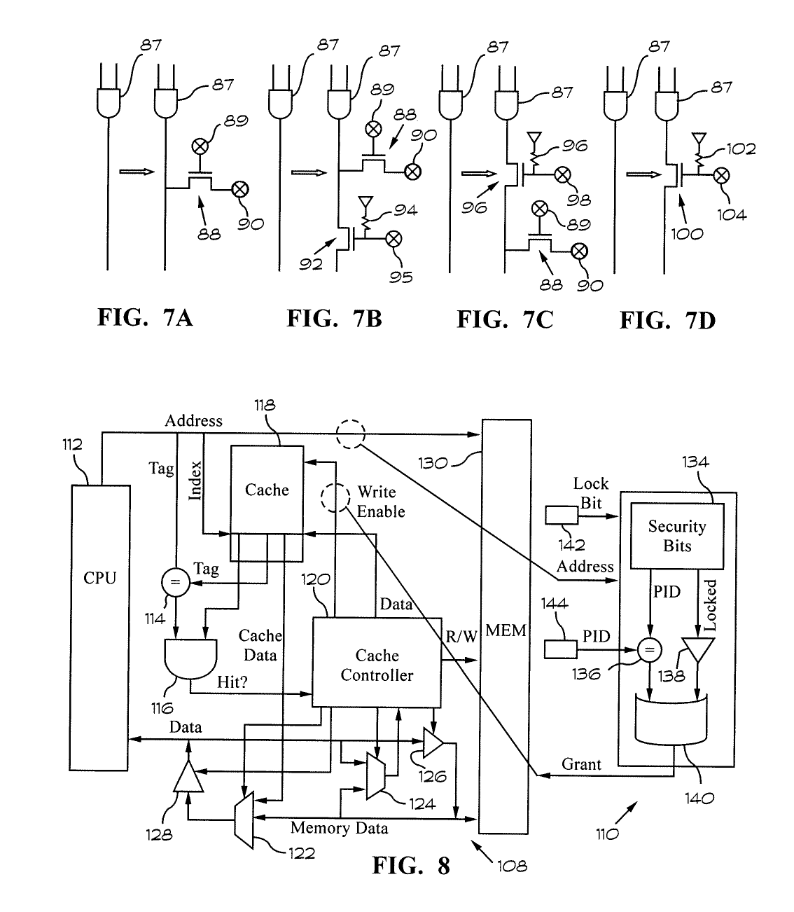

FIGS. 7A-7D show circuit level modifications made for the control plane to perform its intended security functions and for computation plane 45 to be able to execute in the absence of the control plane 46 as further described below.

In one embodiment, an alternative method for disabling links is to physically impede the connection itself. An existing circuit technique called power gating is used for this purpose. Support for power gating is added through the addition of sleep transistors placed between a circuit's logic and its power/ground connections. The sleep transistors act as switches that effectively remove the power supply from the circuit. The circuit is awake when the transistors are activated by a specific signal, which provides power to the circuit allowing it to function normally. Alternatively, the sleep transistors can be given the opposite input and turned off, thus disconnecting the power to the circuit, temporarily removing all functionality, and effectively putting the circuit to sleep.

Sleep transistors are traditionally used to temporarily disable unused portions of an integrated circuit, thereby saving power by preventing leakage current. However, their use is also beneficial for providing the isolation an active monitor requires. With only a small amount of added hardware (two transistors 70, 72 and two resistors 76, 84, shown in FIG. 6) and posts for connectivity to 3-D control plane 46, portions of computation plane 45 can be selectively turned off to force adherence to any specific security policy enforced in the control layer. The exact size of the sleep transistors depends on a variety of factors, which includes the time to turn the circuit on and off and the amount of leakage power savings. These factors are relatively easily varied by changing various physical properties of the sleep transistor, e.g. gate length, oxide thickness and doping. In fact, smaller technology nodes (less than 90 nanometer) need only one sleep transistor due to the use of a lower power supply voltage. Finally, many modern chips already employ power gating on many of their components. In this case, the amount of added hardware necessary to apply security measures is decreased, as only posts to 3-D control plane 46 to carry the control signal are needed.

In addition to selectively removing power from some components on-chip, sleep transistors may be used to perform several key functions on data and control lines required by active monitors. Sleep transistors can be placed on any link that may need to be disabled or controlled. 3-D control plane 46 can manage them by simply providing a post that connects to their gate input. The following functions all use only one or two transistors per line and present a new set of options for trustworthy system development.

FIGS. 7A-7D show four different kinds of circuit level modifications. The sample base circuit is an AND gate 87 and is found at the top of each circuit modification. Tapping requires (FIG. 7A) only one transistor to optionally propagate the signal to 3-D control plane 46, while re-routing (FIG. 7B) and overriding (FIG. 7C) need transistors with pull-up resistors to ensure their continued function for systems omitting 3-D control plane 46. Disabling (FIG. 7D) uses a transistor and a pull-up resistor to uphold the connection in the absence of 3-D control plane 46, while giving 3-D control plane 46 the option of disconnecting the line for systems utilizing it.

Referring to FIG. 7A, a tap transistor 88 is connected to the output of AND gate 87. The gate of a transistor 88 is connected to a post 89, and the drain is connected to a post 90

Tapping can be used to send the requested signals to 3-D control plane 46 without interrupting their original path. As shown in FIG. 7A, a voltage is applied to the gate of transistor 88 to create the additional path of the signal to 3-D control plane 46 as well. This is particularly useful in an analysis of the flow of information on computation plane 45 without affecting its original functionality. Tapping can also be used when security logic on 3-D control plane 46 is dependent on some data in computation plane 45, without the need to change their values in the system. In 3-D cache eviction, monitor tapping is used to access the address of a load or a store instruction to determine whether a cache eviction is allowed, and does not interfere the normal flow of the address through its bus.

Re-routing as shown in FIG. 7B uses a transistor 88 and a second transistor 92 to send the requested signals to 3-D control plane 46 and block their transmission to the originally intended path. A pull-up resistor 94 is attached between the gate of transistor 92 that is disabling the line and a post 95 to force a connection when 3-D control plane 46 is not attached. Re-routing can be used to create new buses between resources on-chip.

FIG. 7C shows a transistor 88 and a transistor 96 connected to the input of an AND gate 87. A pull up resistor 96 is connected between the gate of transistor 96 and a post 98.

Another use of re-routing is using a signal for a different purpose than was originally intended. Once on 3-D control plane 46, the signal can be analyzed and combined with other data from 3-D control 46 or computation plane 45, or simply stored for later use. This can then be coupled with overriding (FIG. 7C) to change control outputs on computation plane 45 based on new control logic in 3-D control plane 46.

Overriding (FIG. 7C) allows blocking the intended value of a signal and modifying it to a desired value for the security layer's function. Overriding uses two transistors and a pull-up resistor much like rerouting. For some security applications, critical control signals need to be changed in order to adhere to a specialized policy that is being enforced by the 3-D control plane. In the 3-D cache eviction monitor overriding is used to change the value of a cache's write enable signal (FIG. 8), to allow injection of a value to allow or deny the eviction of a specific cache line.

FIG. 7D shows a single transistor 100 used to stop the flow of data from the AND gate 87. A pull up resistor 102 is connected between the gate of transistor 102 and a post 104. Disabling (FIG. 7D) allows the flow of data to be completely stopped on a common bus or on a specific signal line. Uses of disabling include the ability to isolate a specific resource from unintended accesses, or enforcement of policies that require tight guarantees on the integrity of data on a shared bus. Many bus protocols work on a mutual trust system, where access to the bus is controlled by the devices that are connected, not by a trusted arbiter. In situations such as this, it is important to preserve trustworthy execution and the confidentiality of data during a sensitive computation. Disabling can be used to forcibly block access to a bus to ensure secure transactions without the possibility of unintended access.

FIG. 8 shows the architecture of a CPU/cache memory hierarchy 108 and a 3-D cache eviction monitor 110 working in concert. In one embodiment, a CPU 112 is connected to comparator 114 and a cache 118. A tag output from cache 118 is also connected to comparator 114. Comparator 114 compares the tags from CPU 112 and cache 118 to form an output that is input to an AND gate 116 that also receives an input from cache 118. The output of AND gate 116 is input to a cache controller 120. Cache controller 120 provides control signal outputs to cache 118, a pair of multiplexers 122 and 124, a pair of tri-state buffers 126 and 128, and to a memory 130. CPU 112 also provides address signal and data to a memory 130.

An address signal from CPU 112 and a lock bit 142 are input to cache eviction monitor 110. Cache eviction monitor 110 includes security bits 134 that provide a process ID (PID) signal that is input to a comparator 136 for comparison to a Process ID (PID) 144. A locked signal is also output from security bits 134. Comparator 136 output and the locked signal are input to an OR gate 140 that has an output connected to cache 118 to provide a write enable signal thereto.

The address of the corresponding load/store is tapped to be sent to 3-D control plane 46, and the cache write-enable signal is overridden in the case of a locked cache line eviction. Lock bit 142 and the Process ID (PID) 144 are also provided to 3-D control plane 46. Once cache monitor 110 receives the load/store address, lock bit 142, and PID, it can determine whether a cache eviction can be granted based on whether the cache line is locked or whether the PID matches, and issue the appropriate override signal on the cache write-enable signal.

In one embodiment, the custom architecture of FIG. 8 is implemented in 3-D control plane 46 for eliminating access-driven cache side channel attacks. Concurrent processing platforms present several security issues. Although these architectures provide performance benefits through instruction-level parallelism, their methods of resource sharing leave them vulnerable to side channel attacks. One side channel attack uses a simultaneous multithreaded processor's shared memory hierarchy, exploiting the process-to-process interference through the cache eviction policy to illicitly transfer information. As a result, an attacker thread may be able to extract information, such as a cryptographic key, from a victim thread.

In one embodiment, a method to prevent these attacks uses 3-D control plane 46 to maintain a cache protection structure that indicates, for each cache line, whether it is protected, and if so, for which process. When a different process loads or stores data related to a protected cache line, no eviction will occur, and the data is not cached unless an alternate line is available in the cache protocol being used.

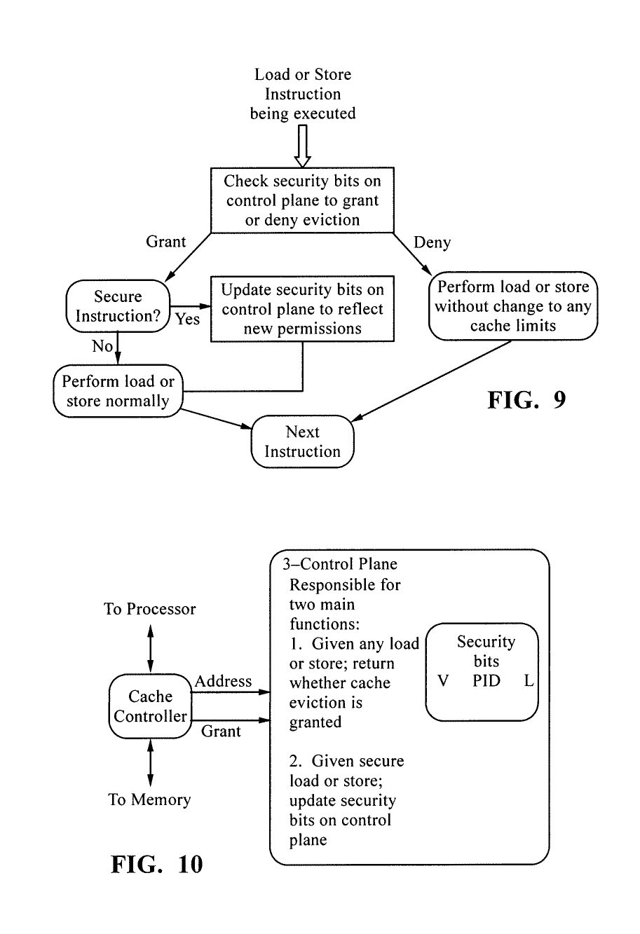

FIG. 9 is a flow chart showing how loads and stores are executed when 3-D control plane 46 is in place. First, the security bits on control plane 46 are checked to grant or deny eviction. If eviction is granted, a determination is made whether there is a secure instruction. If the instruction is secure, the security bits on control plane 46 are updated to reflect new permissions. If the instruction is not secure, then a perform load or store operation is executed. If eviction is denied, a perform load or store without change to any cache limits operation is executed.

FIG. 10 provides a high-level overview of how cache 118 and 3-D control plane 46 interact. Specifically, in one embodiment, the cache protection structure contains memory elements on 3-D control plane 46 to store security bits, which hold the permissions of a process to evict shared cache entries of other processes. With this in place, when instructions proceed to load or store data, these security bits are first checked to determine whether to grant a cache eviction that might otherwise have occurred without policy oversight. As mentioned previously, when 3-D control plane 46 is not attached to the processor, cache 118 functions as normal. However, when 3-D control plane 46 is added, this aforementioned strategy can be used to avoid undesirable cache evictions. This is performed with an updated version of the two instructions load and store. These instructions, named secure load and secure store, will change the security bits in 3-D control plane 46 to reflect the process that currently occupies the line. Effectively, secure load and secure store will modify the necessary bits to ensure that once a cache line is occupied by a process that needs cache eviction control, it cannot be evicted by any other process. This will control a simultaneous multithreaded processor's shared memory and eliminate any threat of an access-driven side channel attack.

Delivery of the previously mentioned required information to 3-D control plane 46 is through the vertical posts. A general idea of the number of posts 3-D control plane 46 needs on a given system is the sum of the number of bits of: the address size, the process ID size, possibly one post for the secure register, and a grant bit post. This results in fewer than 100 vias, which equates to about the silicon space for 50 bits of memory, which is a small and reasonable number of vertical posts to implement a strong security measure.

This disclosure provides exemplary embodiments of the present invention. The scope of the present invention is not limited by these exemplary embodiments. Numerous variations, whether explicitly provided for by the specification or implied by the specification or not, may be implemented by one of skill in the art in view of this disclosure.

What is claimed is:

1. A computing system comprising:
a computation plane that includes one or more dies arranged for performing computation, which, in certain instances, is required to be secure;
a control plane that includes one or more dies performing operations necessary to ensure the security of the entire system;
a plurality of direct electrical connections between the computation plan and control plane; and
a plurality of electronic interfaces arranged to allow the control plane to activate and control portions or the whole of the computation plane for the purposes of increasing the security of its operation.

2. The system of claim 1 further comprising:
a set of electronic interfaces allowing direct electrical access to control structures, gates, networks, and interconnects of the computation plane.

3. The system of claim 2 wherein the interfaces allow for the control plane to be optionally included at fabrication time with no changes required to the computation plane.

4. The system of claim 2 further comprising:
an electronic interface arranged to allow the control plane to block connections on the computation plane.

5. The system of claim 2 further comprising:
an electronic interface arranged to allow the control plane to disable functionality on the computation plane.

6. The system of claim 2 further comprising:
an electronic interface arranged to allow the control plane to monitor the computation plane.

7. The system of claim 2 further comprising:
an electronic interface arranged to allow the control plane to re-route signals and communications on the computation plane.

8. The system of claim 2 further comprising:
an electronic interface arranged to allow the control plane to override the operation of the computation plane in whole or in part.

9. The system of claim 1 wherein side channels and information leaks present on the computation plane are mitigated or prevented by the control plane.

10. The system of claim 9 wherein the control layer is used to prevent information leakage through the memory hierarchy of the computation plane.

11. The system of claim 10 wherein the control layer modifies functions of the on-chip busses to mitigate or prevent information leakage.

12. The system of claim 1 wherein the function of a cache controller of the computation plane is modified.

13. The system of claim 12 wherein the cache controller is modified to mitigate or prevent information leakage.

14. A method for controlling access of a computer processor to a resource, comprising:
(a) blocking uncontrolled access of the computer processor to the resource;
(b) providing a control plane that includes data corresponding to a security policy;
(c) providing a first signal post between the computer processor and the control plane to transfer signals from the computer processor to the control plane;
(d) modifying signals from the computer processor so that the signals conform to the security policy; and
(e) enabling the computer processor to have access through the control plane to transfer signals to the resource that conform to the security policy.

15. The method of claim 14, wherein operation (e) comprises:
providing a second signal post between the computer processor and the control plane to transfer signals that conform with the security policy from the computer processor to the resource.

16. The method of claim 14, wherein operation (e) comprises:
relocating the resource to the control plane so that the computer processor can access the resource only through the signal post under control by the control plane.

17. The method of claim 14, further comprising:
providing a cache eviction monitor in the control plane for eliminating access-driven cache side channel attacks.

18. The method of claim 17, further comprising:
(a) providing memory elements for storing security bits that hold the permissions of a process to evict shared cache entries of other processes; and
(b) comparing the security bits with instructions to load or store data to determine whether to allow a cache eviction.

19. A security system for controlling access of a computer processor to a resource, comprising:
a control plane that includes data corresponding to a security policy;
a first signal post connected between the computer processor and the control plane to transfer signals from the computer processor to the control plane;
a second signal post connected between the computer processor and the control plane to transfer signals that conform with the security policy from the computer processor to the resource;
an apparatus in the control plane for modifying signals from the computer processor so that the signals conform to the security policy so that the computer processor is connected through the control plane to transfer signals to the resource that conform to the security policy;
a cache eviction monitor located in the control plane for eliminating access-driven cache side channel attacks;
memory elements connected to the computer processor for storing security bits that hold the permissions of a process to evict shared cache entries of other processes; and
comparator circuitry arranged for comparing the security bits with instructions to load or store data to determine whether to allow a cache eviction.

20. The security system of claim 19, wherein the resource is located in the control plane so that the computer processor can access the resource only through the signal post under control by the control plane.
